(19) United States
(12) Patent Application Publication
(10) Pub. No.: US 2026/0326852 A1
(43) Pub. Date: Oct. 22, 2026

(54) Method for Providing a Pushing Aid in a Bicycle having Motor Support

(71) Applicant: Robert Bosch GmbH, Stuttgart (DE)

(72) Inventors: Matthias Weinmann, Balingen (DE); Christian Reisige, Tuebingen (DE); Daniel Baumgaertner, Neustetten (DE)

(21) Appl. No.: 18/994,888

(22) PCT Filed: Jul. 18, 2023
(86) PCT No.: PCT/EP2023/069933

§ 371 Date: Jan. 15, 2025

(30) Foreign Application Priority Data
Jul. 18, 2022 (DE) 10 2022 207 289.8

(51) Int. Cl. B62M 6/50; B62J 45/415

(52) U.S. Cl. CPC B62M 6/50; B62J 45/4152

(57) ABSTRACT

A method for providing motor support in a bicycle includes (i) activating a pushing aid in response to a request for providing the pushing aid being present, the pushing aid only being activated when an angle of inclination of the bicycle lies below a specified threshold value, and (ii) providing the pushing aid by a motor of the bicycle following activation of the pushing aid as long as the request for providing the pushing aid is present, the motor providing the pushing aid even when the angle of inclination of the bicycle exceeds the specified threshold value.

### PRIOR ART

The present invention relates to a method for providing a pushing aid in a bicycle with motor support.

In the case of electric bicycles, so-called e-bikes, it is known that a pushing aid is provided. Such is provided in particular at speeds up to 6 km/h and results in motor support of the rider, even if the rider does not pedal. For safety reasons, however, this function is stopped when it is detected that the bicycle is in an overhead position. This is the case, for example, when the bicycle is turned over for a tire change in the workshop.

Electric bicycles are often used off paved paths. This can result in overcoming obstacles where it is necessary to raise the front wheel and pull the handlebars toward the rider.

### DISCLOSURE OF THE INVENTION

The method according to the present invention for providing a pushing aid in a bicycle with motor support comprises activating a pushing aid in response to a request for providing the pushing aid being present, the pushing aid only being activated when an angle of inclination of the bicycle lies below a specified threshold value, and providing the pushing aid by a motor of the bicycle following activation of the pushing aid as long as the request for providing the pushing aid is present, the motor providing the pushing aid even when the angle of inclination of the bicycle exceeds the specified threshold value.

The method according to the present invention for providing a pushing aid in a bicycle with motor support further comprises activating a pushing aid in response to a request for providing the pushing aid being present, and providing the pushing aid by a motor of the bicycle following activation of the pushing aid as long as the request for providing the pushing aid is present and independent of an angle of inclination of the bicycle.

A device according to the present invention for providing a pushing aid in a bicycle with motor support comprises a control unit that is configured to activate a pushing aid in response to a request for providing the pushing aid being present, the pushing aid only being activated when an angle of inclination of the bicycle lies below a specified threshold value, and to provide the pushing aid by a motor of the bicycle following activation of the pushing aid as long as the request for providing the pushing aid is present, the motor providing the pushing aid even when the angle of inclination of the bicycle exceeds the specified threshold value.

A device according to the present invention for providing a pushing aid in a bicycle with motor support further comprises a control unit that is configured to activate a pushing aid in response to a request for providing the pushing aid being present, and to provide the pushing aid by a motor of the bicycle following activation of the pushing aid as long as the request for providing the pushing aid is present and independent of an angle of inclination of the bicycle.

The method according to the invention allows the pushing aid to be provided even when the angle of inclination of the bicycle increases above the threshold value, which is particularly the case if the bicycle is tilted overhead. This allows a rider of the bicycle to hold the bicycle by its handlebars so that when the pushing aid is activated and provided, the bicycle is driven by the rear wheel and the front wheel of the bicycle rises until the bicycle is almost in a complete overhead position. The rear wheel overtakes the front wheel until the rear wheel of the bicycle has moved to a foremost position under the front wheel. The bicycle can thus be moved overhead by its rider, similar to a wheelbarrow, wherein the bicycle only touches the ground with its rear wheel and is held by the rider on the handlebars.

If the rear wheel of the bicycle is moved against a face, it can be pressed against the face with its rear wheel by the user and moves upwards along the face first with the rear end. The side of the bicycle facing away from the face is held by the rider. If a top edge of the face is reached, the bicycle can be placed by the rider on the surface bounded by the face and the rider can also climb up the face without the bicycle.

The method according to the invention thus creates a climbing aid for a bicycle.

The pushing aid is a function of the bicycle in which the bicycle is driven forward by the motor of the bicycle, even if no force is exerted by a rider on the pedals of the bicycle. A pushing aid is thus suitable to assist a rider in pushing the bicycle. This is preferably done when requested by the rider of the bicycle, i.e. when a request for providing the pushing aid is provided. The request for providing the pushing aid may be triggered in a variety of ways, for example by pressing a button or generally by the rider actuating an operating element. If the rider triggers the request for providing the pushing aid, the pushing aid is activated and subsequently continuously provided until the request for providing the pushing aid is no longer present.

However, the pushing aid is initially activated only when the angle of inclination of the bicycle is below a specified threshold value. This means that the pushing aid is only activated if the bicycle is not tilted so far that it is overhead. The specified threshold value defines from which angle of inclination the bicycle is considered overhead. The angle of inclination is in particular an angle between a horizontal and a longitudinal axis of the bicycle.

If the pushing aid has been activated, it will be provided continuously in the following as long as the request for providing the pushing aid is present, which is requested by the rider. If the angle of inclination of the bicycle exceeds the specified threshold value, the pushing aid continues to be provided. Checking the angle of inclination with respect to the specified threshold value is thus preferably carried out only once when activating the pushing aid and is not rechecked when the pushing aid is operated further. This preferably results in the pushing aid being provided only if the bicycle is overhead when it has been tilted to this position with the pushing aid already activated. This ensures that the pushing aid is not activated unintentionally, for example in a workshop situation, as the bicycle is typically already in an overhead position when the pushing aid is unintentionally activated and the angle of inclination of the bicycle would therefore lie above the specified threshold value. At the same time, if the pushing aid is activated intentionally, it can continue to be provided even if the bicycle tilts beyond the specified threshold value. This ensures motor support for the rear wheel even when the bicycle is in a tilted position of the bicycle and the rear wheel of the bicycle can be moved upwards by pressing it against a face.

Apart from this, the method according to the invention also provides a pushing aid, which functions independently of the angle of inclination of the bicycle. This is achieved by activating a pushing aid in response to a request for providing the pushing aid being present, and providing the pushing aid by the motor of the bicycle following activation of the pushing aid as long as the request for providing the pushing aid is present and independent of an angle of inclination of the bicycle. This configuration allows for versatile applications of the pushing aid and assists the rider in a variety of situations.

In particular, the method for providing the pushing aid also provides a pushing aid that assists the user when the angle of inclination of the bicycle is greater than the angle of inclination of a subsurface. Providing the pushing aid by the motor is also carried out when the angle of inclination of the bicycle is greater than the angle of inclination of a subsurface.

The method for providing the pushing aid thus also provides in particular a pushing aid, which assists the user when the angle of inclination of the bicycle is so large that the bicycle only touches the ground with its rear wheel and is held by the rider on the handlebars. Providing the pushing aid by the motor is also carried out when the angle of inclination of the bicycle is so great that the bicycle only rests on the ground with its rear wheel and is held by the driver on the handlebars.

Preferably, the motor of the bicycle interrupts providing the pushing aid in response to the request for providing the pushing aid no longer being present. In unwanted situations or when the pushing aid is no longer needed, it can be purposefully interrupted by the rider of the bicycle.

It is also advantageous if reactivating the pushing aid after interrupting the provision of the pushing aid is carried out, wherein reactivation occurs in response to the request for providing the pushing aid being present again, the pushing aid being reactivated when the angle of inclination of the bicycle exceeds the specified threshold value. For example, in some situations it may be necessary for the rider to grip the bicycle when holding the bicycle if the rear wheel of the bicycle is up against a face. If the rider grips in this way, they may not be able to continuously trigger the request for providing the pushing aid, for example because they must release a button provided for this purpose. It is therefore advantageous if reactivating the pushing aid, i.e. activating the pushing aid after it has already been activated, takes place independently of the present angle of inclination. The reactivation of the pushing aid is in particular independent of the present angle of inclination if the pushing aid has previously been activated and less than a predefined time period having elapsed since the last activation or deactivation of the pushing aid. Alternatively or additionally, the reactivation of the pushing aid takes place independently of the present angle of inclination, if the bicycle has had an angle of inclination during the previous activation of the pushing aid that was above the specified threshold value.

Furthermore, it is advantageous if the method further comprises sensing a time interval from the time when the request for providing the pushing aid is no longer present and reactivating the pushing after interrupting the provision of the pushing aid in response to the request for providing the pushing aid being present again, wherein reactivating the pushing aid also takes place when the angle of inclination of the bicycle lies above the specified threshold, if the time interval until the request for providing the pushing aid is present is less than or equal to a predefined time period, and reactivating the pushing aid only takes place when the angle of inclination of the bicycle lies below the specified threshold value, if the time interval until the request for providing the pushing aid being present is greater than the predefined time period. This means that a time interval begins to be sensed, for example by a timer, once the rider interrupts the request for providing the pushing aid once. If the sensed time interval is comparatively short, i.e. if it is less than or equal to the predefined time period, it is not checked again whether the angle of inclination of the bicycle lies above the specified threshold value before reactivating the pushing aid. If the time interval is comparatively long, i.e. if it is greater than or equal to the predefined time period, it is checked whether the angle of inclination of the bicycle lies below the specified threshold value before reactivating the pushing aid again and the pushing aid is activated only if this is the case. In other words, this means that if the rider briefly interrupts the request to provide the pushing aid, the pushing aid can be activated again even if the bicycle is in an overhead position. However, if the request for providing the pushing aid is interrupted for an extended period of time, it is assumed that it is not known what situation the bicycle is in and whether, for example, a climbing procedure is still being carried out. Thus, it is rechecked whether the bicycle is oriented at an angle of inclination that lies below the specified threshold value.

It is also advantageous if the motor prevents or decelerates reverse rolling of the bicycle by providing a torque in response to the request for providing the pushing aid no being longer present. The prevention or deceleration of reverse rolling of the bicycle is in particular given by a so-called Hill-Hold function. If the request for providing the pushing aid is interrupted, it is advantageous both when the wheel is being pushed on level ground or slightly uphill, and when it is climbing, not to alternate the pushing aid with freewheeling of the rear wheel, but to ensure that the bicycle does not roll unexpectedly towards the rider pushing it. This is achieved by preventing or decelerating the reverse rolling of the bicycle. In particular, a torque is provided by the motor of the bicycle, which counteracts the bicycle rolling downhill.

It is also advantageous if the request for providing the pushing aid is present when a predefined user action is performed, in particular when an operator presses a button. However, different operator actions are conceivable, for example, a pushing aid by placing the hand on a sensor could be advantageous.

Furthermore it is advantageous if the angle of inclination is an angle between a horizontal and a longitudinal axis of the bicycle, wherein the threshold value is greater than or equal to 45 degrees. Further preferably, the threshold value is greater than or equal to 45 degrees. In any case, it is advantageous if the threshold value is selected such that regular travel of the bicycle is no longer possible when the angle of inclination of the bicycle lies above the threshold value. Preferably, the angle of inclination is an angle which increases from 0 degrees when the front wheel of the bicycle is raised.

Preferably, when the pushing aid is activated by the motor, a continuous propulsion of the rear wheel of the bicycle is caused. When using the rear wheel of the bicycle as a climbing aid by pressing the rear wheel on a surface, the rear wheel of the bicycle is thus continuously raised along the surface.

The method according to the invention is preferably executed by a device according to the invention.

A bicycle comprising the device according to the invention is further advantageous. Such a bicycle has all the advantages of the device according to the invention. The bicycle is preferably designed such that when the rear wheel of the bicycle is subdivided into a circumferential angle of 360 degrees about a rear axle of the bicycle, wherein a point of contact of the rear wheel with a road surface is at 0 degrees, and wherein a rearmost point of the rear wheel is at 90 degrees, no structural elements of the bicycle are arranged outside the circumference of the rear wheel in an angular range of the circumferential angle from 0 degrees to 135 degrees. This is achieved in particular by the fact that the bicycle does not have a mud guard and/or a luggage carrier or these structural elements are correspondingly restricted in their dimensions. In this way, the bicycle can be tilted about its rear axle by the rider and there is no collision between a structural element of the bicycle and the road surface as long as the bicycle is moved along the horizontal surface or along a rising surface. This prevents a mud guard of the bicycle from hitting the ground when the bicycle is tilted, for example, thus limiting the range of functions of the climbing aid.

### BRIEF DESCRIPTION OF THE DRAWINGS

Embodiment examples of the invention are explained in detail below with reference to the accompanying drawings. The drawing shows:

FIG. 1 a schematic illustration of a bicycle with a device according to the invention for providing motor support,

FIG. 2 a schematic illustration of a use of the device according to the invention for providing motor support as a climbing aid, and

FIG. 3 shows a flow chart of a method according to the invention for providing motor support for a bicycle.

FIG. 1 shows an electric bicycle 1, on which a device for providing motor support of the bicycle 1 is arranged. The device comprises a control unit 2, by means of which the method according to the invention is carried out.

A motor 3 is arranged on the bicycle 1, which drives a rear wheel 7 of the bicycle 1. A button 4 is further arranged on the bicycle 1, which can be used by a rider of the bicycle 1 to trigger a request for providing a pushing aid, wherein the request for providing the pushing aid is present as long as the button 4 is actuated by the rider.

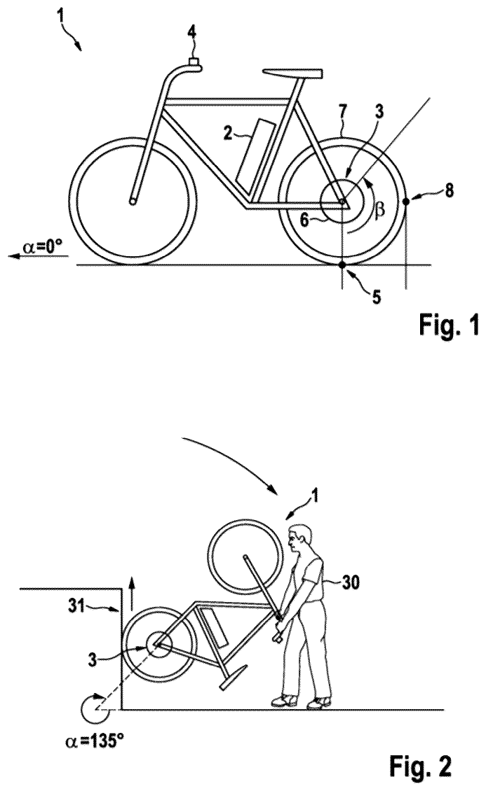

The device according to the invention provides a climbing aid for the bicycle 1. In particular, this makes it possible to provide the pushing aid even if the bicycle 1 is tilted to such an extent that it has an angle of inclination that exceeds a specified threshold value. The bicycle 1 can thus be tilted very far over its rear axle 6 without deactivating the pushing aid. This allows the bicycle 1 to be handled as shown in FIG. 2.

For example, the rider 30 dismounts from the bicycle 1 when a higher plateau behind a face 31 is to be reached, wherein the face 31 is too high for the bicycle 1 to ride it over it regularly. The bicycle 1 is held by the rider 30 on the handlebars and the button 4 is pressed. The pushing aid provides a continuous propulsion of the rear wheel 7 and the bicycle 1 can tilt over the handlebars such that the rear wheel 7 acts as the leading wheel of the bicycle 1. This is shown in FIG. 2. If the rear wheel 7 is brought into contact with the face 31, wherein the rear wheel 7 is preferably pressed against the face 31 by the user 30, the rear wheel 7 begins to rise along the face 31. This process may continue until the rear wheel of the bicycle 1 has reached the higher plateau and is riding up onto it. The front wheel of the bicycle 1 with the handlebars can now also be placed on the higher plateau by the rider 30. The rider 30 can now climb onto the plateau without the bicycle 1 and thus overcome the face 31. Subsequently, a regular ride on the bicycle 1 may be continued. It is noted that the situation depicted in FIG. 2 is merely to be seen as exemplary.

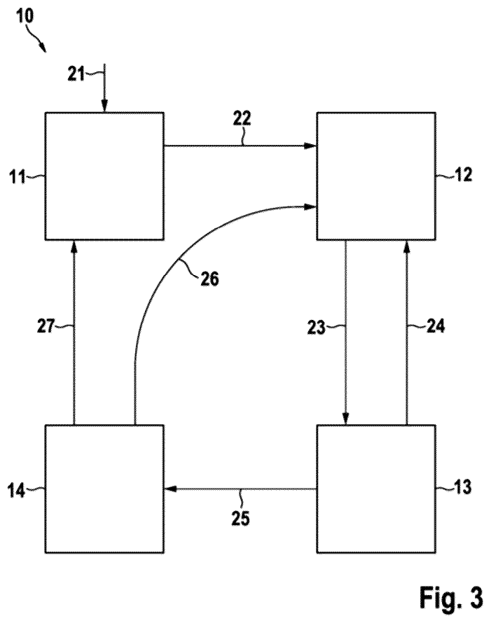

To enable a climbing aid, the method according to the invention is used, which is shown in an advantageous flow diagram in FIG. 3. The method according to the invention takes into account safety-relevant parameters as well as achieves a comfortable use of a pushing aid as a climbing aid.

If a regular ride of the rider 30 with the bicycle 1 is ended by the rider dismounting from the bicycle 1, which is the case in the first transition condition 21, the control unit 2 is brought into a first operating state 11 in which the pushing aid is not active, but can be activated by an input of the user 30, more specifically when a request for providing the pushing aid is present.

In a second operating state 12, the pushing aid is active and is provided by the motor 3 of the bicycle 3. To enter the second operating state 12, the second transition condition 22 must be satisfied.

The second transition condition 22 is given when the rider 30 actuates the button 4 and thus a request for providing the pushing aid is triggered. At the same time, a tilt sensor is used to check the value of the angle of inclination α of the bicycle 1. The angle of inclination is an angle between a horizontal and a longitudinal axis of the bicycle 1. The second operating state 12 is assumed and thus the pushing aid is activated only when the measured angle of inclination α of the bicycle 1 lies below a specified threshold value. For example, the threshold value is given at 45° or 90°. If the detected angle of inclination lies above the specified threshold value, the system remains in the first operating state 11, in which the pushing aid is not active, because the second transition condition 22 is not satisfied. This is the case because the bicycle 1 is tilted at such an angle of inclination that it can be assumed that it may have been turned upside down for repair work. If the measured angle of inclination α of the bicycle 1 lies below the specified threshold value, it can be inferred that the bicycle 1 is in a regular operating state. In this case, the pushing aid is activated in response to the presence of the request for providing the pushing aid.

The activated pushing aid in the second operating state 12 ensures that the motor 3 causes continuous propulsion of the rear wheel 7 of the bicycle 1. The pushing aid is provided by the motor 3 for as long as the button 4 is actuated by the rider 30 and is thus provided for as long as the request for providing the pushing aid is present. It is not rechecked whether the angle of inclination of the bicycle 1 lies above or below the specified threshold value. This means that in the second operating state 12, the pushing aid is also provided when the angle of inclination of the bicycle 1 increases above the specified threshold value.

In a third operating state 13, the motor 3 is actuated such that reverse rolling of the bicycle 1 is prevented or at least reduced, i.e., decelerated, by providing a torque by the motor 3. This actuation of the motor 3 to prevent or decelerate reverse rolling is also referred to as hill holding.

The third operating state 13 is reached starting from the second operating state 12 when a third transition condition 23 is satisfied. This is the case when the button 4 is released by the rider 30, and thus the request for providing the pushing aid is no longer present. This is therefore advantageous as in the second operating state 12 no further check is made of the current angle of inclination of the bicycle 1. Preventing or decelerating reverse rolling prevents the bicycle 1 from rolling towards the rider 30 in an uncontrolled manner. For example, the situation shown in FIG. 2 could occur and if the button 4 is accidentally released, the rear wheel 7 would roll towards the rider 30. This is prevented by decelerating or preventing reverse rolling by the motor 3. Optionally, reverse rolling is initially completely prevented and then increasingly permitted by reducing the torque by the motor 3, so that the bicycle 1 can be brought under control in a controlled manner.

However, preventing or decelerating reverse rolling by the motor 3 in the third operating state 13 is only provided for a limited time, among other things to prevent the motor 3 overheating. If preventing or decelerating reverse rolling is automatically ended in the third operating state 13, which is the case when a fifth transition condition 25 is satisfied, the control unit 2 is brought into a fourth operating state 14. For example, the fifth transition condition 25 is given when the third operating state 13 is active above a predefined time interval.

In the fourth operating state 14, neither the pushing aid is provided, nor is decelerating or preventing reverse rolling of the bicycle 1 prevented by actuating the motor 3 accordingly.

In both the third operating state 13 and the fourth operating state 14, a situation can occur in which the rider 30 again requires support of the pushing aid, for example because the bicycle 1 has not yet fully climbed the face 31 to be overcome. In this case, the rider 30 actuates the button 4 again, thereby satisfying a sixth transition condition 26 or a fourth transition condition 24. If the sixth transition condition 26 or the fourth transition condition 24 is satisfied, the control unit 2 switches form the third operating state 13 or the fourth operating state 14 back to the second operating state 12. The pushing aid is thereby again provided by the motor 3. This is done without rechecking the present angle of inclination of the bicycle 1. This means that the pushing aid is again provided in the second operating state 12, regardless of whether the angle of inclination of the bicycle 1 lies below or above the specified value threshold.

When the control unit 2 is in the fourth operating state 13, it switches back to the first operating state 11 when a seventh transition condition 27 is satisfied.

The seventh transition condition 27 is satisfied if a predefined time period has elapsed since the user 30 released the button 4 with the third transition condition 23. Thus, a time interval is measured starting with the release of the button 4 by the user 30 and thus with the presence of the third transition condition 23. If this time interval is less than a predefined time period, for example less than ten seconds, the control unit 2 remains in the respective present third or fourth operating state 13, 14. If the measured time interval is greater than the predefined time period, the seventh transition condition 27 is satisfied and the control unit 2 changes from the fourth operating state 14 to the first operating state 11.

If the sensed time interval since the user 30 has released the button 4 is greater than the predefined time period, it can be assumed that the control unit 2 has already transitioned from the third operating state 13 to the fourth operating state 14.

The seventh transition condition 27 causes the control system 2 to be brought from the fourth operating state 14 back to the first operating state 11. This means that after the user 30 has released the button 4, it is rechecked again when the button 4 is actuated again whether the inclination angle of the bicycle 1 lies below the specified threshold value and the pushing aid is only provided in this case. This ensures that the pushing aid is not activated in particular if the rider 30 releases the button 4 for a longer period of time, without ensuring that the angle of inclination of the bicycle lies below the specified threshold value. For example, a situation could occur in which the bicycle 1 lies on the level behind the face 31 to be overcome. For example, it should be avoided that the pushing aid is unintentionally actuated by the rider 30 when the rider also climbs the face 31 to reach the bicycle 1.

For an optimum use of the climbing aid according to the invention and thus the method 10 according to the invention, it is advantageous if the bicycle 1 is designed so as to also bring it into the position described in FIG. 2. For example, it is typically advantageous if the bicycle 1 does not have a mud guard or luggage rack, as these could often collide with the road surface if the bicycle 1 is tilted above the specified threshold value. In principle, however, mud guards and luggage racks are also possible, provided they are arranged accordingly. However, it is advantageous if a rear region of the rear wheel 7 of the bicycle 1 is not structurally restricted. For example, the rear wheel 7 of the bicycle 1 is to be considered such that it has a circumferential angle of 360° about a rear axle 6 of the bicycle 1. The circumferential angle is merely a description used herein and is not a structural element. The circumferential angle is defined such that it has 0 degrees on the road surface upon horizontal standing of the bicycle 1 at the point of contact 5 of the rear wheel 7. At a rearmost point of the rear wheel 7, i.e. at a rearmost point of the rear wheel 7 along the longitudinal axis of the bicycle 1, the circumferential angle has a value of 90°. In FIG. 1, the circumferential angle is shown graphically and moves counterclockwise about the rear axle 6 of the bicycle 1 when viewed on the left side of the bicycle 1. It is particularly advantageous if no structural elements of the bicycle 1 are arranged outside a circumference of the rear wheel 7 in an angular range β of the circumferential angle between 0 degrees and 135 degrees. For example, a bicycle stand or similar can be arranged within the circumference of the rear wheel 7.

The method according to the invention thus only checks whether the e-bike is “not overhead” when the pushing aid is activated. As long as the rider continues to exert the “conscious and ongoing action” required according to EN 15194, e.g. pressing the button 4, the “overhead” detection is also not used to deactivate the pushing aid.

This makes it possible to walk behind the bicycle 1 and tilt the handlebars and front wheel towards the rider 30 (similar to a wheelbarrow, the driving rear wheel is in the front). This makes it easier to climb stairs, for example, as the front wheel is in the air and there is a little more pressure on the rear wheel, which leads to better traction.

By lightly pushing the rotating rear wheel 7 against a rock or a face 31, you can also ride up a >1.5 m high rock face without much effort using the pushing aid, put the bike down at the top and climb up behind it yourself. This is also referred to as “climb assist”. Otherwise, the heavy e-bike would have to be carried up on its own.

Furthermore, the “overhead” information is used to activate an existing “Hill Hold” function when the button 4 is released, which regulates the motor speed to zero speed with slowly decreasing torque, if necessary. This additionally increases the safety when the rider accidentally releases button 4.

The bicycle 1 therefore only stops and then slowly approaches the rider due to the decreasing allowed torque for the speed control to zero rpm.

If the rider 30 presses button 4 again during Hill Hold or after an applicable time, the overhead information is further ignored in this time (e.g. 10 s) and the pushing aid is immediately continued.

An exemplary procedure of the method can be summarized as follows:
The rider 30 activates the pushing aid in a “NOT overhead” state
The rider 30 lets the front wheel rise, e.g. stands behind the bicycle 1 and leans the handlebars towards himself
The bicycle 1 is now “overhead” but no switch-off as long as the rider 30 presses button 4
When button 4 is released (depending on the slope and in any case “overhead”), Hill Hold becomes active
Pressing button 4 again within an applicable time or during Hill Hold causes the “overhead” information to be ignored.

In addition to the written disclosure hereinabove, we make explicit reference to the disclosure of FIGS. 1 through 3.

1. A method for providing a pushing aid for a bicycle having motor support, comprising:
activating a pushing aid in response to a request for providing the pushing aid being present, the pushing aid only being activated when an angle of inclination of the bicycle lies below a specified threshold value, and
providing the pushing aid by a motor of the bicycle following activation of the pushing aid for as long as the request for providing the pushing aid is present, the motor providing the pushing aid even when the angle of inclination of the bicycle exceeds the specified threshold value.

2. A method for providing a pushing aid in a bicycle having motor support, comprising:
activating a pushing aid in response to a request for providing the pushing aid being present, and
providing the pushing aid by a motor of the bicycle following activation of the pushing aid as long as the request for providing the pushing aid is present and independent of an angle of inclination of the bicycle.

3. The method according to claim 1, further comprising:
interrupting the provision of the pushing aid by the motor of the bicycle in response to the request for providing the pushing aid being no longer present.

4. The method according to claim 3, further comprising:
reactivating the pushing aid after interrupting the provision of the pushing aid, wherein reactivation occurs in response to the request for providing the pushing aid being present again, the pushing aid being reactivated when the angle of inclination of the bicycle exceeds the specified threshold value.

5. The method according to claim 3, further comprising:
sensing a time interval from the time at which the request for providing the pushing aid is no longer present, and
reactivating the pushing aid after interrupting the provision of the pushing aid in response to the request for providing the pushing aid being present again,
wherein the reactivation of the pushing aid also occurs when the angle of inclination of the bicycle is above the specified threshold if the time interval up to the presence of the request for providing the pushing aid is less than or equal to a predefined time period, and
wherein the reactivation of the pushing aid occurs only when the angle of inclination of the bicycle is below the specified threshold value, if the time interval until the presence of the request for providing the pushing aid is greater than the predefined time period.

6. The method according to claim 1, further comprising:
preventing or decelerating reverse rolling of the bicycle by providing a torque by the motor in response to the request for providing the pushing aid being no longer present.

7. The method according to claim 1, wherein the request for providing the pushing aid is present when a predefined user action is performed,

8. The method according to claim 1, wherein the angle of inclination is an angle between a horizontal and a longitudinal axis of the bicycle.

9. The method according to claim 1, wherein, when the pushing aid is activated by the motor, a continuous propulsion of the rear wheel of the bicycle is caused.

10. The method according to claim 1, wherein providing the pushing aid by the motor also occurs when the angle of inclination of the bicycle is greater than the angle of inclination of a subsurface.

11. The method according to claim 1, wherein providing the pushing aid by the motor also occurs when the angle of inclination of the bicycle is so great that the bicycle only rests on the ground with its rear wheel and is held by the rider on the handlebars.

12. A device for providing a pushing aid in a bicycle having motor support comprising a control unit which is configured to:
activate a pushing aid in response to a request for providing the pushing aid being present, the pushing aid only being activated when an angle of inclination of the bicycle lies below a specified threshold value, and
provide the pushing aid by a motor of the bicycle following activation of the pushing aid, as long as the request for providing the pushing aid is present, the pushing aid being provided by the motor even when the angle of inclination of the bicycle exceeds the specified threshold value.

13. (canceled)

14. A bicycle comprising a device according to claim 12, wherein the bicycle is designed such that when the rear wheel of the bicycle is subdivided into a circumferential angle of 360 degrees about a rear axle of the bicycle, a contact point of the rear wheel with a road surface is at 0 degrees, and a rearmost point of the rear wheel is at 90 degrees, no structural elements of the bicycle are arranged outside a circumference of the rear wheel in an angular range of the circumferential angle from 0 degrees to 135 degrees.

15. The method according to claim 1, wherein the request for providing the pushing aid is present when a user presses an operating element.

16. The method according to claim 15, wherein the operating element is a button.

17. The method according to claim 8, wherein the threshold value is greater than or equal to 45 degrees.
